(19) United States
(12) Patent Application Publication
(10) Pub. No.: US 2025/0142585 A1
(43) Pub. Date: May 1, 2025

(54) CONFIGURATION SWITCH

(71) Applicant: QUALCOMM Incorporated, San Diego, CA (US)

(72) Inventors: Ahmed Attia ABOTABL, San Diego, CA (US); Diana MAAMARI, San Diego, CA (US); Sherif ELAZZOUNI, San Diego, CA (US)

(21) Appl. No.: 18/499,916

(22) Filed: Nov. 1, 2023

(51) Int. Cl. H04W 72/232; H04W 76/28

(52) U.S. Cl. CPC H04W 72/232; H04W 76/28

(57) ABSTRACT

Various aspects of the present disclosure generally relate to wireless communication. In some aspects, a user equipment (UE) may receive downlink control information (DCI) to switch from a first set of configurations for a cell to a second set of configurations for the cell. The UE may switch from the first set of configurations to the second set of configurations. Numerous other aspects are described.

### INTRODUCTION

Aspects of the present disclosure generally relate to wireless communication and to techniques and apparatuses for communication configurations.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed at a user equipment (UE). The method may include receiving downlink control information (DCI) to switch from a first set of configurations for a cell to a second set of configurations for the cell. The method may include switching from the first set of configurations to the second set of configurations.

Some aspects described herein relate to a method of wireless communication performed at a network entity. The method may include transmitting DCI to switch from a first set of configurations for a cell or channel to a second set of configurations for a cell or channel. The method may include scheduling one or more communications based at least in part on a switch from the first set of configurations to the second set of configurations.

Some aspects described herein relate to an apparatus for wireless communication at a UE. The apparatus may include one or more memories and one or more processors coupled to the one or more memories. The one or more processors may be configured to receive DCI to switch from a first set of configurations for a cell to a second set of configurations for the cell. The one or more processors may be configured to switch from the first set of configurations to the second set of configurations.

Some aspects described herein relate to an apparatus for wireless communication at a network entity. The apparatus may include one or more memories and one or more processors coupled to the one or more memories. The one or more processors may be configured to transmit DCI to switch from a first set of configurations for a cell or channel to a second set of configurations for a cell or channel. The one or more processors may be configured to schedule one or more communications based at least in part on a switch from the first set of configurations to the second set of configurations.

Some aspects described herein relate to a non-transitory computer-readable medium that stores a set of instructions for wireless communication by a UE. The set of instructions, when executed by one or more processors of the UE, may cause the UE to receive DCI to switch from a first set of configurations for a cell to a second set of configurations for the cell. The set of instructions, when executed by one or more processors of the UE, may cause the UE to switch from the first set of configurations to the second set of configurations.

Some aspects described herein relate to a non-transitory computer-readable medium that stores a set of instructions for wireless communication by a network entity. The set of instructions, when executed by one or more processors of the network entity, may cause the network entity to transmit DCI to switch from a first set of configurations for a cell or channel to a second set of configurations for a cell or channel. The set of instructions, when executed by one or more processors of the network entity, may cause the network entity to schedule one or more communications based at least in part on a switch from the first set of configurations to the second set of configurations.

Some aspects described herein relate to an apparatus for wireless communication. The apparatus may include means for receiving DCI to switch from a first set of configurations for a cell to a second set of configurations for the cell. The apparatus may include means for switching from the first set of configurations to the second set of configurations.

Some aspects described herein relate to an apparatus for wireless communication. The apparatus may include means for transmitting DCI to switch from a first set of configurations for a cell or channel to a second set of configurations for a cell or channel. The apparatus may include means for scheduling one or more communications based at least in part on a switch from the first set of configurations to the second set of configurations.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of cell discontinuous transmission (DTX) and/or discontinuous reception (DRX), in accordance with the present disclosure.

FIG. 5A and FIG. 5B are diagrams illustrating an example of switching configurations, in accordance with the present disclosure.

FIG. 6 is a diagram illustrating an example of cell DTX/DRX configuration indices, in accordance with the present disclosure.

FIG. 7 is a diagram illustrating an example process performed, for example, at a UE or an apparatus of a UE, in accordance with the present disclosure.

FIG. 8 is a diagram illustrating an example process performed, for example, at a network entity or an apparatus of a network entity, in accordance with the present disclosure.

FIG. 9 is a diagram of an example apparatus for wireless communication, in accordance with the present disclosure.

FIG. 10 is a diagram illustrating an example of a hardware implementation for an apparatus employing a processing system, in accordance with the present disclosure.

FIG. 11 is a diagram illustrating an example of an implementation of code and circuitry for an apparatus, in accordance with the present disclosure.

FIG. 12 is a diagram of an example apparatus for wireless communication, in accordance with the present disclosure.

FIG. 13 is a diagram illustrating an example of a hardware implementation for an apparatus employing a processing system, in accordance with the present disclosure.

FIG. 14 is a diagram illustrating an example of an implementation of code and circuitry for an apparatus, in accordance with the present disclosure.

### DETAILED DESCRIPTION

Power consumption is a large percentage of network costs, and most network power consumption comes from a radio access network (RAN). A network entity (e.g., network node 110) of the RAN may operate to conserve power. In some examples, to conserve power, a network entity may use a cell discontinuous transmission (DTX) mode. A cell DTX mode includes periodic DTX cycles, where each DTX cycle includes an active period during which the network entity uses power for transmission and a non-active period during which the network entity reduces its power and does not transmit signals (or does not transmit certain signals). The active period may also be referred to as an “active duration” or an “active time”. The non-active period may also be referred to as an “inactive period,” a “non-active duration,” an “inactive duration,” or an “non-active period.” The network entity may also use a cell discontinuous reception mode (DRX) mode that includes periodic DRX cycles, where each DRX cycle includes an active period during which the network entity uses power for monitoring and reception and a non-active period during which the network entity reduces its power and does not monitor for and receive signals (or does not receive certain signals). A user equipment (UE) may also operate in a DRX mode.

In some examples, when the network entity is in a non-active period, the network entity may enter a sleep state. Sleeping may involve turning off a radio and one or more other components or functions. Turning off or switching off a radio may include removing power from the radio such that the radio is not fully operating or not operating with full power. The network entity may wake up for an active period. Waking up may involve turning on a radio and one or more other components or functions. Turning on or switching on a radio may include adding power to the radio such that the radio is fully operating or operating with full power.

In some examples, a network entity may transmit downlink control information (DCI) to a UE to indicate an activation or deactivation of a cell DTX/DRX mode of the network entity. The UE may conform its communication to the cell DTX/DRX mode of the network entity. For example, the UE may not transmit to the network entity during a non-active period of a cell DRX mode of the network entity, or monitor for communications from the network entity during a non-active period of a cell DTX mode of the network entity.

When the cell DTX/DRX mode is activated with the DCI, one or more configurations for the UE, such as a physical uplink control channel (PUCCH) configuration or a physical downlink shared channel (PDSCH) configuration, are expected to be switched (activated or deactivated). The configurations at the UE may be for the cell of the network entity. Switching to the one or more configurations associated with the cell DTX/DRX mode involves radio resource control (RRC) signaling, which increases latency and consumes signaling resources, because RRC signaling includes multiple transmissions that may have a lot of content.

Instead of relying on RRC signaling to switch a configuration of the UE when a cell DTX/DRX is activated or deactivated, it may be quicker and simpler for the network entity to dynamically switch the configuration of the UE using DCI. According to various aspects described herein, a network entity may transmit a DCI to switch a UE from a first set of configurations for a cell of the network entity to a second set of configurations for the cell. The DCI switch may be when activation or deactivation of a cell DTX and/or DRX configuration is involved. That is, a set of configurations for a cell may include a set of configurations associated with a cell DTX mode and/or a cell DRX mode. For example, the network entity may transmit, to the UE, a DCI indicating activation/deactivation of a cell DTX/DRX. The DCI may also indicate to the UE a switch from the first set of configurations for the cell to the second set of configurations for the cell. A set of configurations for the cell may include one or more configurations the UE uses that are specific to the cell. A set of configurations may include, for example, any combination of a PUCCH configuration, a PDSCH configuration, a configuration for channel state information reference signal (CSI-RS) reporting, a configuration for sounding reference signals (SRSs), a configuration for scheduling requests (SR), or a configuration for physical random access channel (PRACH) messages. That is, the set of configurations at the UE may be for the cell and may be associated with a cell DTX/DRX mode of the network entity. In some examples, the first set of configurations are expected to be different than the second set of configurations. The configuration types may be different and/or the configuration parameters may be different.

The use of a DCI to switch configurations at the UE allows for UE configuration switching to occur at a time that is independent of a time when a cell DTX/DRX mode is activated or deactivated. In some aspects, configurations may be switched at the UE more frequently than when the cell DTX/DRX mode of the network entity is activated, because a DCI uses less time and signaling resources than RRC signaling.

Switching a UE to the second set of configurations may include the network entity activating the second set of configurations at the UE, and switching a UE from the first set of configurations may include the network entity deactivating the first set of configurations at the UE. A set of configurations may be for at least one cell. A set of configurations for a cell may include a set of configurations for one or more channels and/or one or more bandwidth parts (BWPs). In some aspects, power control at the UE may change within a configuration. Different configurations at the UE may be suitable depending on the network load and the cell DTX/DRX mode.

Note that the set of configurations at the UE is associated with the cell DTX/DRX mode that is active but is not a set of configurations for the cell DTX/DRX mode itself. In some examples, a network entity may use a DCI to switch the configurations a UE is using based at least in part on whether the cell DTX mode or the DRX mode is activated at the network entity, but the network entity may not be indicating a switch or configuration of the cell DTX/DRX mode with the DCI.

By indicating a configuration switch at the UE with a DCI, the network entity may switch configurations at the UE more flexibly than only with RRC signaling (RRC reconfiguration), which is not dynamic and takes time and resources. As a result, the network entity and the UE may reduce latency and conserve signaling resources.

In some aspects, configurations with a specific set of parameters or configurations of a specific configuration type may be identified with a configuration index. For example, a DCI may indicate an index of a configuration (e.g., PRACH configuration) to be activated/deactivated when a cell DTX/DRX mode is activated. There may be multiple PRACH configurations for which the UE has information. The configuration index may be indicated by extra bits in the DCI. In this way, the network entity may have flexibility to dynamically select a configuration with little overhead in the same DCI used to indicate cell DTX/DRX activation or deactivation. As a result, the UE configuration is changed for optimal operation without increasing latency for an RRC configuration or consuming a large amount of signaling resources.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

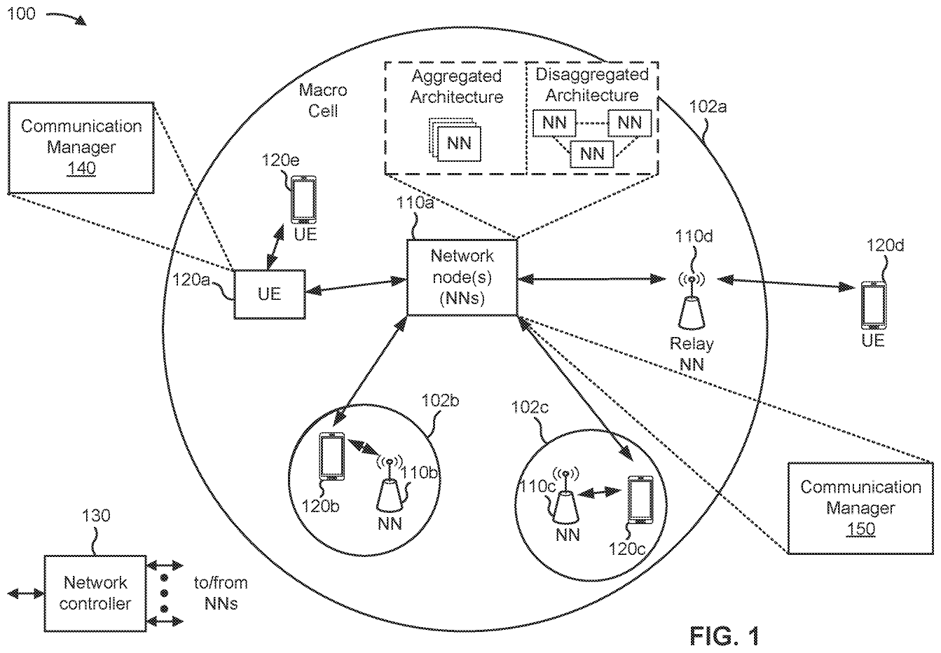

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

The electromagnetic spectrum is often subdivided, by frequency/wavelength, into various classes, bands, channels, etc. In 5G NR, two initial operating bands have been identified as frequency range designations FR1 (410 MHZ-7.125 GHZ) and FR2 (24.25 GHZ-52.6 GHZ). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive DCI to switch from a first set of configurations for a cell to a second set of configurations for the cell. The communication manager 140 may switch from the first set of configurations to the second set of configurations. Additionally, or alternatively, the communication manager 140 may perform one or more other operations described herein.

In some aspects, the network entity may include a communication manager 150. As described in more detail elsewhere herein, the communication manager 150 may transmit DCI to switch from a first set of configurations for a cell or channel to a second set of configurations for a cell or channel. The communication manager 150 may schedule one or more communications based at least in part on a switch from the first set of configurations to the second set of configurations. Additionally, or alternatively, the communication manager 150 may perform one or more other operations described herein.

As indicated above, FIG. 1 is provided as an example. Other examples may differ from what is described with regard to FIG. 1.

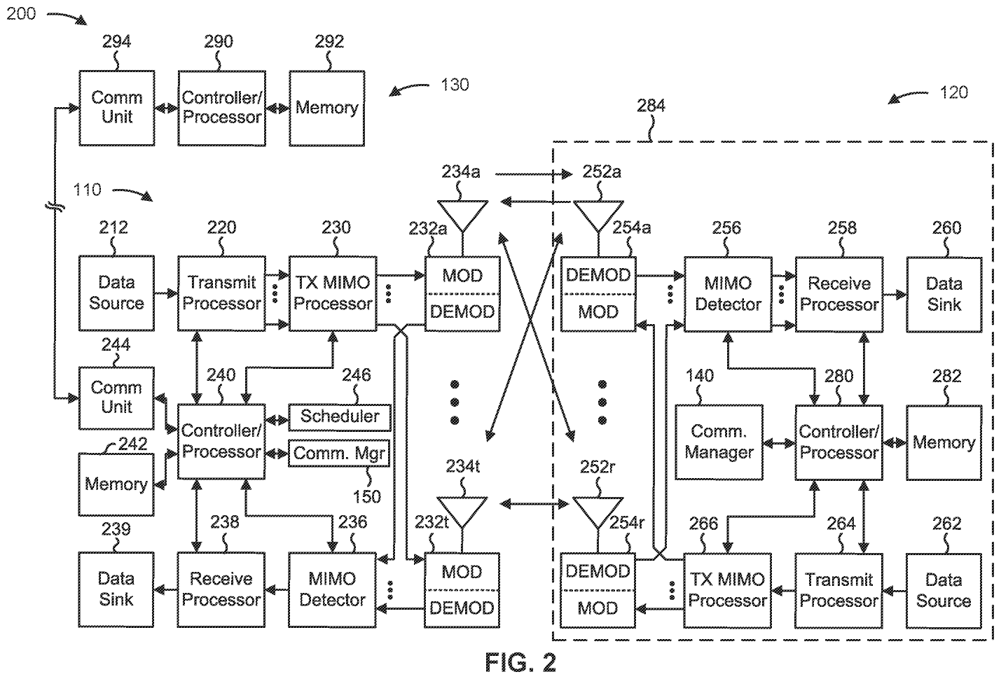

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

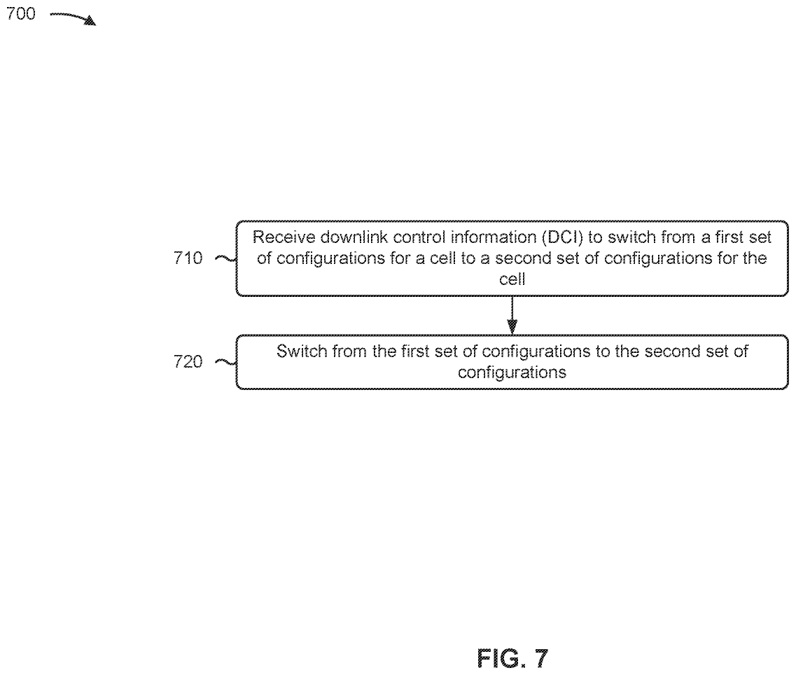

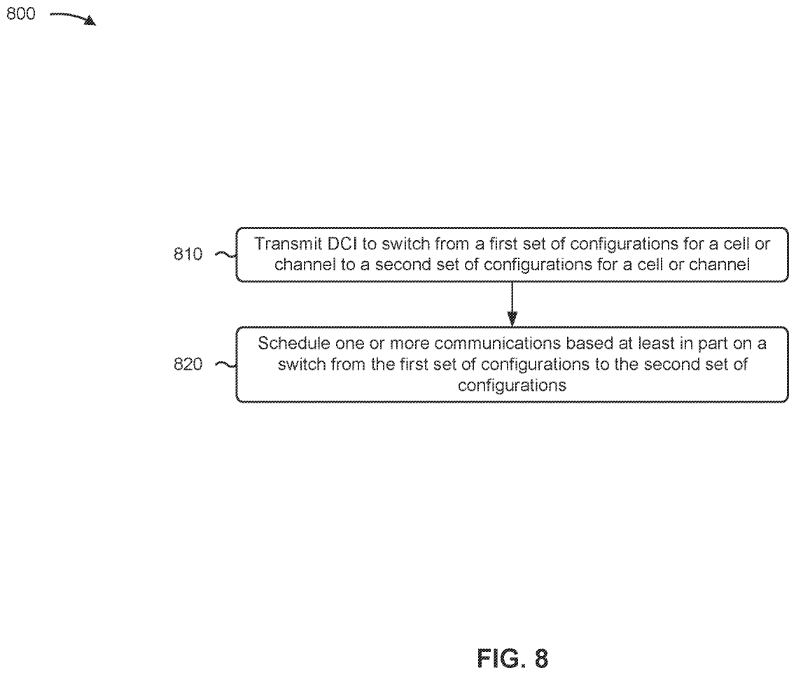

The controller/processor 240 of the network node 110, the controller/processor 280 of the UE 120, and/or any other component(s) of FIG. 2 may perform one or more techniques associated with switching configurations, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a UE (e.g., a UE 120) includes means for receiving DCI to switch from a first set of configurations for a cell to a second set of configurations for the cell; and/or means for switching from the first set of configurations to the second set of configurations. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., a network node 110) includes means for transmitting DCI to switch from a first set of configurations for a cell or channel to a second set of configurations for a cell or channel; and/or means for scheduling one or more communications based at least in part on a switch from the first set of configurations to the second set of configurations. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

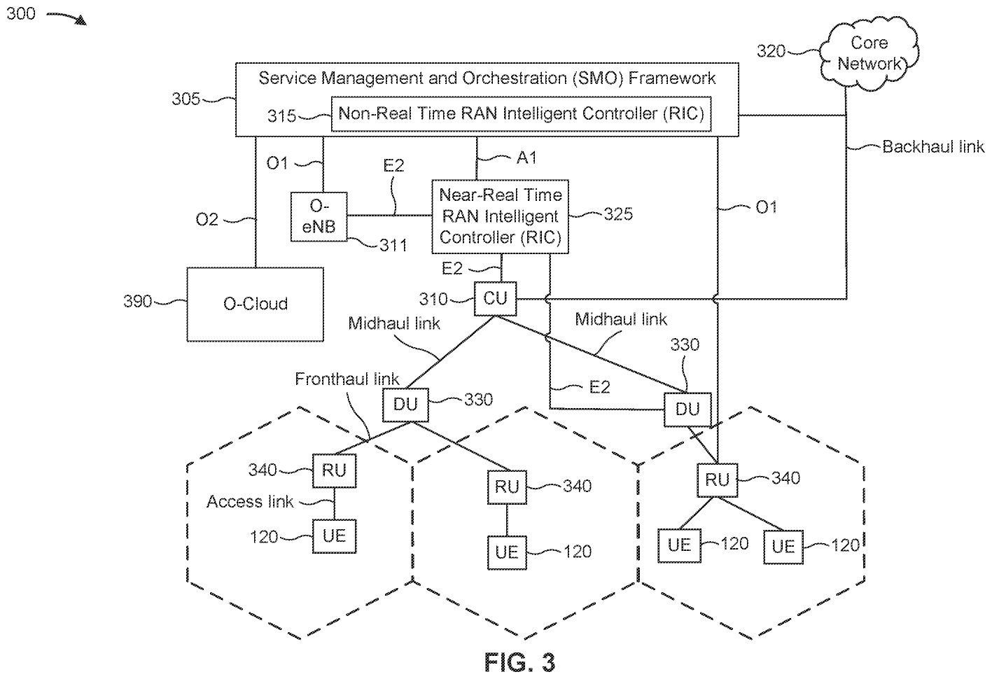

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or PRACH extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-cNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

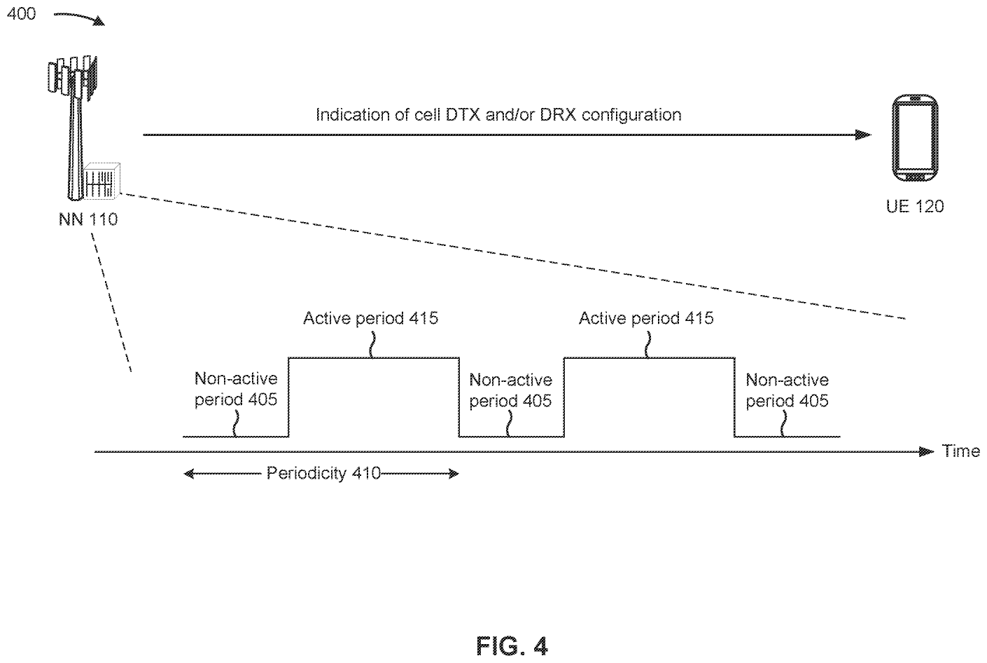

FIG. 4 is a diagram illustrating an example 400 of cell DTX and/or DRX, in accordance with the present disclosure. As shown in FIG. 4, example 400 includes a UE 120 in communication with a network entity (e.g., network node (NN) 110). In some examples, the UE 120 may be in a connected state (e.g., an RRC connected state) with the network node 110.

Power consumption is a large percentage of network costs, and most network power consumption comes from a RAN. A network entity (e.g., network node 110) of the RAN may operate to conserve power. In some examples, to conserve power, a network entity may use a cell DTX mode. A cell DTX mode includes periodic DTX cycles, where each DTX cycle includes an active period during which the network entity uses power for transmission and a non-active period during which the network entity reduces its power and does not transmit signals (or does not transmit certain signals). The network entity may also use a cell DRX mode that includes periodic DRX cycles, where each DRX cycle includes an active period during which the network entity uses power for monitoring and reception and a non-active period during which the network entity reduces its power and does not monitor for and receive signals (or does not receive certain signals). A UE may also operate in a DRX mode. A UE may align its DRX cycle with that of the cell DTX cycle.

As shown in example 400, the network node 110 may transmit an indication of a cell DTX and/or DRX configuration to the UE 120. The configuration may be for cell DTX, cell DRX, or both cell DTX and cell DRX. The configuration may indicate a non-active period 405 (which may also be referred to as an “uplink and/or downlink channel restriction window”) for the cycle. The configuration may indicate a starting time of the non-active period 405 (e.g., a time offset), a duration of the non-active period 405, and/or a periodicity 410 of the non-active period 405, among other examples. One or more types of physical channels or signals may be restricted during the non-active period 405 (e.g., a restricted channel or signal that is scheduled or configured during the non-active period 405 may be dropped by the network node 110 and/or the UE 120). The UE 120 may be expected to not transmit or receive particular channels or signals during the non-active period 405. In this way, the network node 110 may enter a sleep state during the non-active period 405. For example, for downlink communications, the UE may drop reception of a PDCCH in a type-3 CSS, an SPS communication, a CSI-RS for generating CSI, and/or a CSI-RS for propagation delay compensation, among other examples. Downlink channels or signals restricted during the non-active period 405 may include periodic and/or semi-persistent CSI-RSs (e.g., including tracking reference signals (TRSs)), (PRSs), PDCCH communications scrambled with a UE-specific radio network temporary identifier (RNTI), PDCCHs in a type-3 CSS (e.g., a group-common PDCCH), and/or SPS physical downlink shared channel (PDSCH) communications, among other examples. Additionally, or alternatively, for uplink communications, the UE may drop transmission of an SR, a CG communication, and/or CSI feedback, among other examples. Uplink channels or signals restricted during the non-active period 405 may include scheduling requests, periodic and/or semi-persistent CSI reports, periodic and/or semi-persistent sounding reference signals (SRSs), and/or CG physical uplink shared channel (PUSCH) communications, among other examples. As further shown, cell DTX and/or DRX may include active periods 415 outside of (e.g., between) non-active periods 405. Physical channel or signal restrictions applicable to the non-active period 405 may not be applicable to the active period 415.

As indicated above, FIG. 4 is provided as an example. Other examples may differ from what is described with regard to FIG. 4.

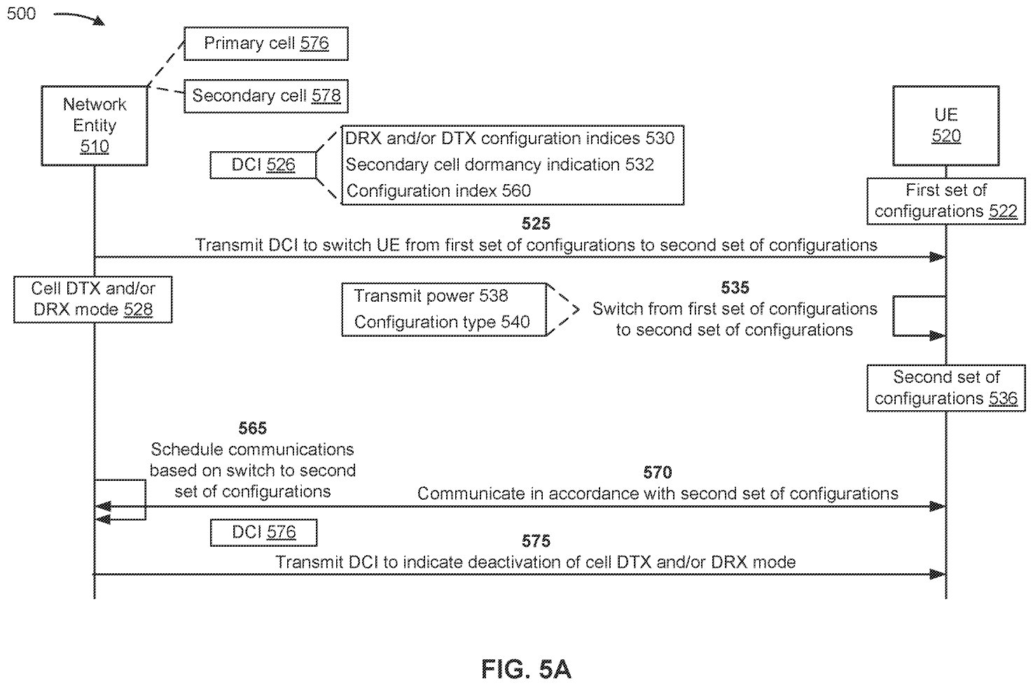

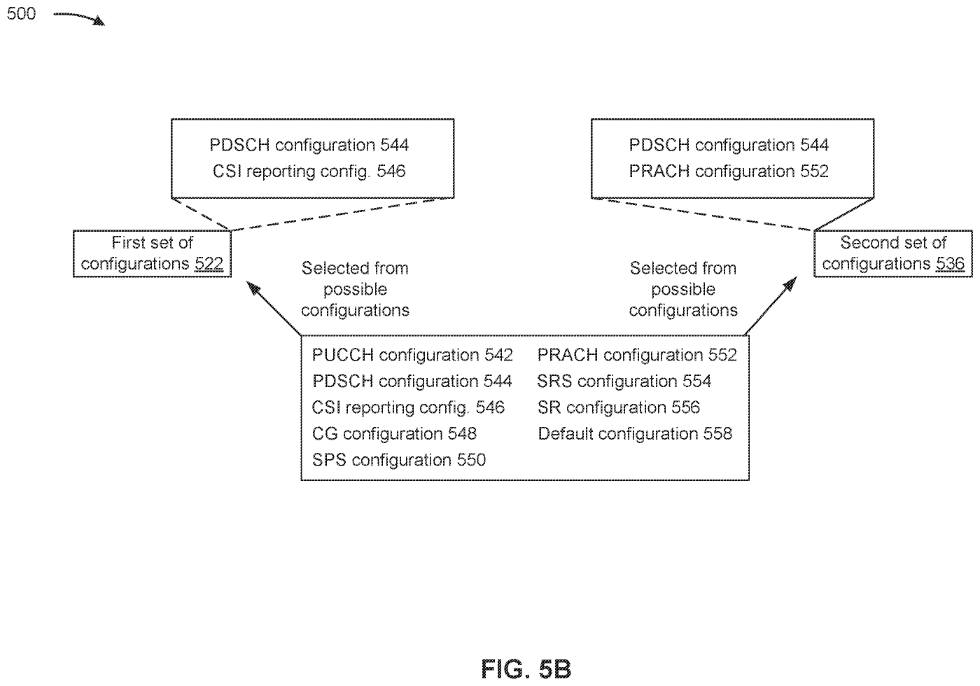

FIG. 5A and FIG. 5B are diagrams illustrating an example 500 of switching configurations, in accordance with the present disclosure.

In some examples, a network entity may transmit DCI (e.g., group common (GC) DCI) to a UE to indicate an activation or deactivation of a cell DTX/DRX mode of the network entity. The UE may conform its communication to the cell DTX/DRX mode of the network entity. For example, the UE may not transmit to the network entity during a non-active period of a cell DRX mode of the network entity, or monitor for communications from the network entity during a non-active period of a cell DTX mode of the network entity.

When the cell DTX/DRX mode is activated with the DCI, one or more configurations for the UE, such as a physical uplink control channel (PUCCH) configuration or a physical downlink shared channel (PDSCH) configuration, arc expected to be switched (activated or deactivated). The configurations at the UE may be for the cell of the network entity. Switching to the one or more configurations associated with the cell DTX/DRX mode involves radio resource control (RRC) signaling, which increases latency and consumes signaling resources, because RRC signaling includes multiple transmissions that may have a lot of content.

Instead of relying on RRC signaling to switch a configuration when a cell DTX/DRX is activated or deactivated, it may be quicker and simpler for the network entity to dynamically switch the configuration using DCI. According to various aspects described herein, a network entity may transmit a DCI to switch from a first set of configurations to a second set of configurations when activation or deactivation of a cell DTX and/or DRX configuration is involved. For example, the network entity may transmit, to the UE, DCI indicating activation/deactivation of a cell DTX/DRX. The DCI may also indicate a switching from the first set of configurations to the second set of configurations. A set of configurations may include one or more configurations. Switching to the second set of configurations may include activating the second set of configurations, and switching from the first set of configurations may include deactivating the first set of configurations. A set of configurations may be for at least one cell. A set of configurations for a cell may include a set of configurations for one or more channels. In some aspects, power control at the UE may change within a configuration. Different configurations may be suitable depending on the network load and the cell DTX/DRX mode. Note that the set of configurations is associated with the cell DTX/DRX mode but is not a set of configurations for the cell DTX/DRX mode.

By indicating a configuration switch at the UE with a DCI, the network entity may optimize the cell DTX/DRX mode without RRC signaling (RRC reconfiguration), which is not dynamic and takes time and resources. As a result, the network entity and the UE may reduce latency and conserve signaling resources.

In some aspects, the behavior with an activation DCI may be different from the behavior with a deactivation DCI. For example, the activation DCI may indicate a set of configurations, and the deactivation DCI may not indicate any set of configurations because the UE may be expected to keep the last active configuration or switch to a default configuration.

A set of configurations may involve one or more types of configurations. For example, in some aspects, a configuration in a set of configurations may include a PUCCH configuration. The PUCCH configuration may indicate time and/or frequency resources for uplink control messages from a UE to a network entity, such as a bandwidth, a slot allocation, a physical resource block (PRB) set and/or an uplink control information (UCI) data source. In some aspects, a configuration may include a PDSCH configuration. The PDSCH configuration may indicate time and/or frequency resources for downlink messages from a network entity to a UE, such as PRBs or a bandwidth part (BWP) size. The PDSCH configuration may indicate other parameters, such as an MCS or scrambling information.

A configuration may include a configuration for CSI-RS reporting. CSI is channel state information that indicates a quality of transmissions on a channel. A CSI-RS is a reference signal from a network entity that is measured by a UE, and a CSI report is a report associated with the measurements. A network entity may use CSI to observe channel conditions. The CSI-RS reporting configuration may indicate, for example, a resource for CSI-RSs, CSI interference measurement resources, resources for reporting CSI, a report type, a frequency of reporting, and/or a codebook type.

A configuration may include a CG configuration or an SPS configuration. A CG includes periodic resources that a UE can use for transmission without a scheduling grant from a network entity. The CG configuration may indicate a resource allocation associated with CG uplink communications (e.g., in a time domain, frequency domain, spatial domain, and/or code domain) and a periodicity at which the resource allocation is repeated. In some examples, the CG configuration may identify a resource pool or multiple resource pools that are available to the UE for an uplink transmission. The SPS configuration may indicate resources for transmissions by a UE and a periodicity or interval of the resources.

A configuration may include a configuration for an SRS. An SRS is a reference signal transmitting on an uplink from a UE to a network entity that can be measured by the network entity to determine a quality of an uplink channel. The SRS configuration may indicate resources, a frequency span, and/or a periodicity for SRSs.

A configuration may include an SR configuration. An SR is a request from a UE to a network entity for a scheduling grant to transmit resources. The SR configuration may indicate resources for SRs, a timer value for a prohibition timer (during which the UE cannot transmit another SR), and/or a maximum quantity of SR transmissions.

A configuration may include a PRACH configuration or a configuration for PRACH messages. A UE may use a random access channel (RACH) procedure to connect to a network entity after being in an idle state. The RACH procedure may include transmission of a random access preamble message from the UE to the network entity, and the network entity transmitting a random access response. A PRACH message is a RACH message. The PRACH configuration may indicate resources for PRACH messages, beam information, power information, and/or random access preamble information. In some aspects, the set of configurations may include one of various configurations, but the set of configurations may be small (e.g., a set of CG indices).

Example 500 of FIG. 5A shows a network entity 510 (e.g., network node 110) and a UE 520 (e.g., a UE 120) that may communicate with one another via a wireless network (e.g., wireless network 100). Example 500 shows the indication of a configuration switch using DCI. The UE 520 may be operating with a first set of configurations 522 (e.g., PUCCH configuration and a CSI reporting configuration).

As shown by reference number 525, the network entity 510 may transmit DCI 526 that switches the UE 520 from the first set of configurations 522 to a second set of configurations 536. Transmitting the DCI 526 may include providing the DCI 526 to the UE 520 and/or the UE 520 obtaining the DCI 526 from the network entity 510. The DCI 526 may be associated with a cell DTX and/or DRX mode 528. The DCI 526 may indicate activation or deactivation of the cell DTX/DRX mode 528. The DCI 526 may include DRX configuration indices 530, such as a DRX configuration index and/or a DTX configuration index, for the cell DTX/DRX mode 528.

As shown by reference number 535, the UE 520 may switch from the first set of configurations 522 to the second set of configurations 536. The switch may include deactivating the first set of configurations and activating the second set of configurations. The switch may change a transmit power 538 with a configuration or between configurations. In some aspects, switching may include switching from a first set of parameters to a second set of parameters for the same configuration type 540.

FIG. 5B shows that the first set of configurations 522 and the second set of configurations 536 may each include a combination of configurations selected from multiple configurations. The first set of configurations 522 may have a different set of parameters than the second set of configurations 536. For example, the UE 520 may switch from a first set of parameters (e.g., time and frequency resources) for a PUCCH configuration 542 and a first set of parameters for a PDSCH configuration 544 to a second set of parameters (e.g., different time and/or frequency resources) for the PUCCH configuration 542 and a second set of parameters for the PDSCH configuration 544. In some aspects, switching may include switching configuration types, such as switching from the PUCCH configuration 542 and the PDSCH configuration 544 to a CSI reporting configuration 546. This switch may include deactivating the PUCCH configuration 542 and the PDSCH configuration 544 and activating the CSI reporting configuration 546.

In some aspects, switching from the first set of configurations 522 to the second set of configurations 536 may include switching from any combination of parameters and configuration types to another combination of parameters and configuration types. Examples of configuration types may also include a CG configuration 548, an SPS configuration 550, a PRACH configuration 552, an SRS configuration 554, or an SR configuration 556, among other configuration types. In some aspects, the second set of configurations 536 may include a default configuration 558 (e.g., a default set of parameters for a configuration, a default type of configuration). In an example, shown in FIG. 5B, the first set of configurations 522 may include the configuration types of a PDSCH configuration 544 and a CSI reporting configuration 546. The second set of configurations 536 may include the configuration types of the PDSCH configuration 54 and a PRACH configuration 552.

In some aspects, configurations with a specific set of parameters or configurations of a specific configuration type may be identified with a configuration index 560. For example, the DCI 526 (e.g., GC DCI) may also indicate an index of the PRACH configuration 552 to be activated/deactivated when cell DTX/DRX mode 528 is activated. There may be multiple PRACH configurations for which the UE 520 has information. The configuration index 560 may be indicated by extra bits in the DCI 526. In this way, the network entity 510 may have flexibility to dynamically select a configuration with little overhead in the same DCI used to indicate cell DTX/DRX activation or deactivation. As a result, the UE 520 configuration is changed for optimal operation without increasing latency for an RRC configuration or consuming a large amount of signaling resources.

As shown by reference number 565 in FIG. 5A, the network entity 510 may schedule communications based at least in part on the switch to the second set of configurations 536. For example, the network entity 510 may schedule and transmit CSI-RSs in accordance with the UE 520 switching to a new CSI reporting configuration. In another example, the network entity 510 may schedule resources for the UE 520 in accordance with switching to a PUCCH configuration or a new PUCCH configuration. As shown by reference number 570, the network entity 510 and the UE 520 may communicate in accordance with the second set of configurations. The communications may also be in accordance with whatever cell DTX/DRX mode was activated or deactivated by the DCI 526. In some aspects, the DCI 526 may be a first DCI to indicate activation of the cell DTX and/or DRX mode 528. As shown by reference number 575, the network entity 510 may transmit a second DCI 576 to indicate deactivation of the cell DTX and/or a DRX mode 528.

In some aspects, after receiving the DCI 526 that indicates activation of the cell DTX and/or DRX mode 528, the UE 520 may expect only a deactivation DCI rather than an indication of activation of another DTX/DRX configuration. In some aspects, the UE 520 may expect a deactivation DCI or an indication of activation of another DTX/DRX configuration. By having options for a next DCI after the DCI 526, the network entity 510 may have more options for better efficiency of DCI activation/deactivation. Such efficiency conserves signaling resources and mitigates latency.

Example 500 shows that the cell for the configurations may be a primary cell 576. In some aspects, the DCI 526 may include information for other cells. For example, the DCI 526 may include a secondary cell dormancy indication 532 that indicates a secondary cell 578 that is to go dormant (be deactivated). Including information for secondary cells in the DCI 526 reduces the DCIs that are transmitted and that may be monitored by the UE 520. As a result, the DCI 526 conserves signaling resources.

As indicated above, FIG. 5A and FIG. 5B are provided as an example. Other examples may differ from what is described with regard to FIG. 5A and FIG. 5B.

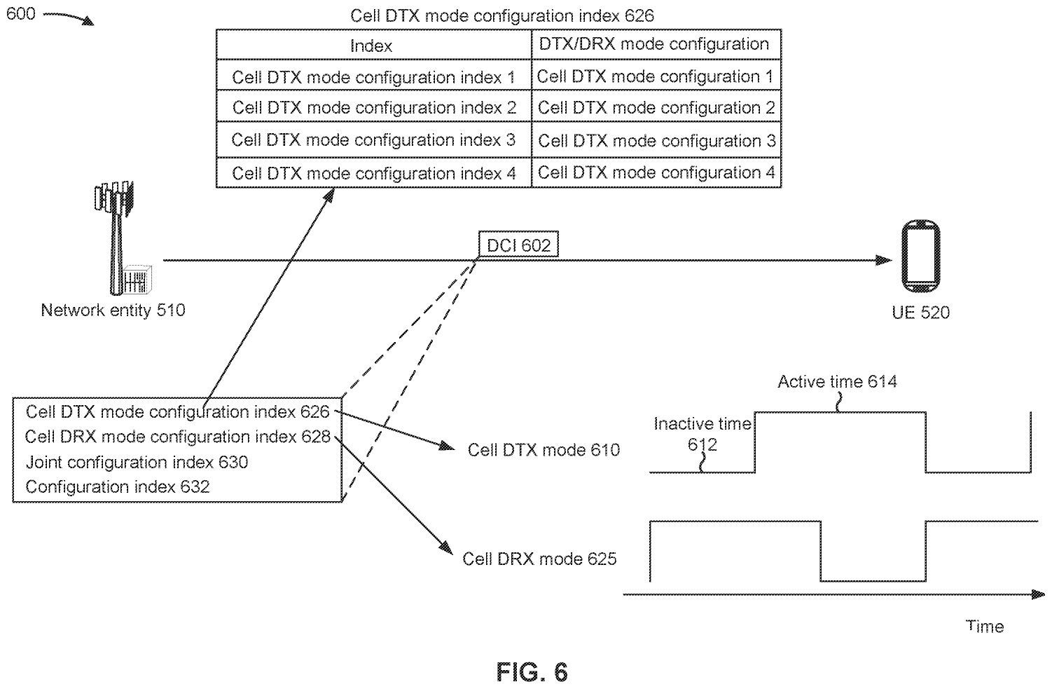

FIG. 6 is a diagram illustrating an example 600 of cell DTX/DRX configuration indices, in accordance with the present disclosure. Example 600 shows a cell DTX mode 610 at the network entity 510, with inactive times 612 and active times 614. Example 600 also shows a cell DRX mode 625 at the network entity 510.

In some aspects, the UE 520 may have information for multiple configurations for a cell DRX mode and/or a cell DTX mode. The network entity 510 may indicate one or more configurations using an index in a DCI 602. For example, the network entity 510 may indicate a configuration of the cell DTX mode 610 with a cell DTX mode configuration index 626. The network entity 510 may indicate a configuration of the cell DRX mode 625 with a cell DRX configuration index 628. In some aspects, the network entity 510 may indicate both a configuration of the cell DTX mode 610 and a configuration of the cell DRX mode 625 with a joint configuration index 630. In some aspects, the network entity 510 may indicate a configuration index 632 for cell DTX and cell DRX configurations that is not joint.

In an example, the UE 520 may have information for multiple cell DTX mode configurations (e.g., cell DTX mode configurations 1 through 4). The DCI 602 may indicate the cell DTX mode configuration using a respective cell DTX mode configuration index 626. Example 600 shows a table for the cell DTX mode configuration index 626, where cell DTX mode configuration index 1 indicates cell DTX mode configuration 1, cell DTX mode configuration index 2 indicates cell DTX mode configuration 2, cell DTX mode configuration index 3 indicates cell DTX mode configuration 3. A similar table may exist for the cell DRX mode configuration index 628.

By using an index to indicate a cell DTX and/or DRX mode, the network entity 510 may use less overhead than if whole configurations are transmitted to the UE 520, which conserves signaling resources. The configuration indices may also provide the network entity 510 more dynamic flexibility, which reduces latency.

As indicated above, FIG. 6 is provided as an example. Other examples may differ from what is described with regard to FIG. 6.

FIG. 7 is a diagram illustrating an example process 700 performed, for example, at a UE or an apparatus of a UE, in accordance with the present disclosure. Example process 700 is an example where the apparatus or the UE (e.g., UE 120, UE 520) performs operations associated with switching configurations in association with a cell DTX/DRX mode.

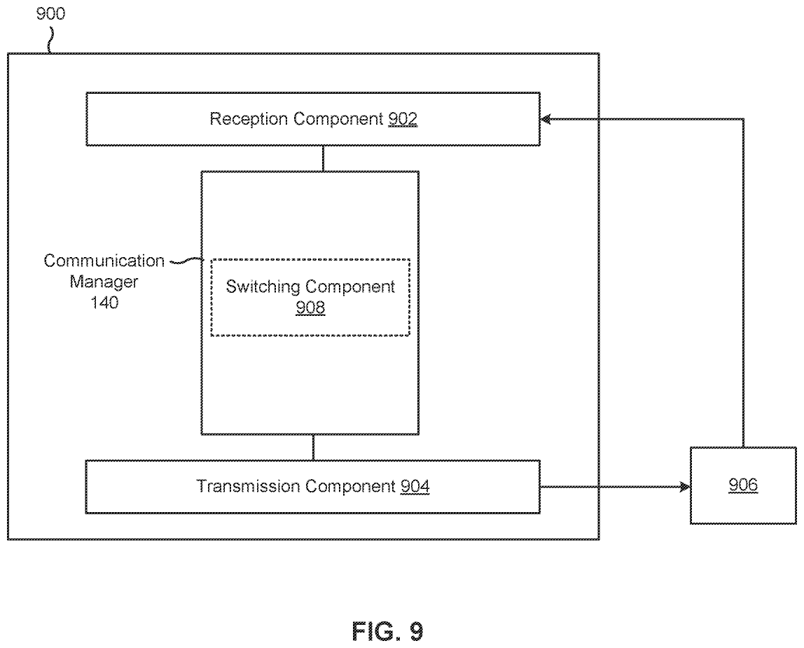

As shown in FIG. 7, in some aspects, process 700 may include receiving DCI to switch from a first set of configurations for a cell to a second set of configurations for the cell (block 710). For example, the UE (e.g., using communication manager 140 and/or reception component 902, depicted in FIG. 9) may receive DCI to switch from a first set of configurations for a cell to a second set of configurations for the cell, as described above.

As further shown in FIG. 7, in some aspects, process 700 may include switching from the first set of configurations to the second set of configurations (block 720). For example, the UE (e.g., using communication manager 140 and/or switching component 908, depicted in FIG. 9) may switch from the first set of configurations to the second set of configurations, as described above.

Process 700 may include additional aspects, such as any single aspect or any combination of aspects described below and/or in connection with one or more other processes described elsewhere herein.

In a first aspect, the DCI indicates activation or deactivation of a cell DTX mode or a cell DRX mode at a network entity.

In a second aspect, alone or in combination with the first aspect, the DCI indicates an index for a cell DTX configuration and an index for a cell DRX configuration.

In a third aspect, alone or in combination with one or more of the first and second aspects, the cell is a primary cell, and the DCI includes a dormancy indication for one or more secondary cells.

In a fourth aspect, alone or in combination with one or more of the first through third aspects, the DCI indicates activation or deactivation of a cell DTX mode or a cell DRX mode at a network entity.

In a fifth aspect, alone or in combination with one or more of the first through fourth aspects, switching from the first set of configurations to the second set of configurations includes switching from a first type of configuration to a second type of configuration.

In a sixth aspect, alone or in combination with one or more of the first through fifth aspects, switching from the first set of configurations to the second set of configurations includes increasing or decreasing a transmit power.

In a seventh aspect, alone or in combination with one or more of the first through sixth aspects, the first set of configurations or the second set of configurations includes one or more of a PUCCH configuration or a PDSCH configuration.

In an eighth aspect, alone or in combination with one or more of the first through seventh aspects, the first set of configurations or the second set of configurations includes a CSI-RS reporting configuration.

In a ninth aspect, alone or in combination with one or more of the first through eighth aspects, the first set of configurations or the second set of configurations includes an SRS configuration.

In a tenth aspect, alone or in combination with one or more of the first through ninth aspects, the first set of configurations or the second set of configurations includes an SR configuration.

In an eleventh aspect, alone or in combination with one or more of the first through tenth aspects, the first set of configurations or the second set of configurations includes a PRACH configuration.

In a twelfth aspect, alone or in combination with one or more of the first through eleventh aspects, the DCI indicates deactivation of a cell DTX mode or a cell DRX mode at a network entity, and the second set of configurations includes a default configuration.

In a thirteenth aspect, alone or in combination with one or more of the first through twelfth aspects, the DCI includes one or more indices for the second set of configurations.

In a fourteenth aspect, alone or in combination with one or more of the first through thirteenth aspects, the DCI is a first DCI and indicates activation of a cell DTX mode or a cell DRX mode at a network entity, and process 700 includes receiving a second DCI that indicates deactivation of the cell DTX mode or the cell DRX mode at the network entity.

In a fifteenth aspect, alone or in combination with one or more of the first through fourteenth aspects, the DCI is a first DCI and activates a first cell DTX mode or a first cell DRX mode at a network entity, and process 700 includes receiving a second DCI that indicates activation of a second cell DTX mode or a second cell DRX mode at the network entity.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network entity or an apparatus of a network entity, in accordance with the present disclosure. Example process 800 is an example where the apparatus or the network entity (e.g., network node 110, network entity 510) performs operations associated with switching configurations in association with a cell DTX/DRX mode.

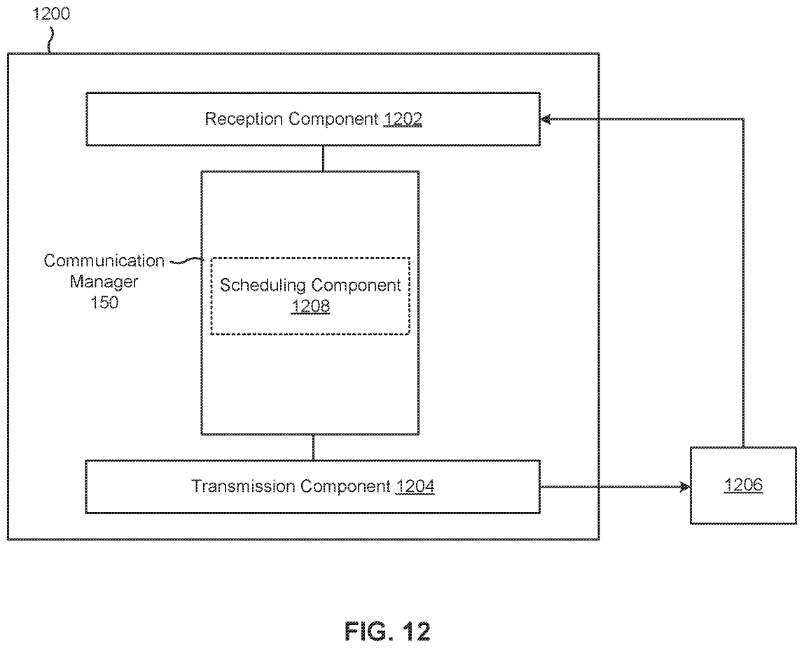

As shown in FIG. 8, in some aspects, process 800 may include transmitting DCI to switch from a first set of configurations for a cell or channel to a second set of configurations for a cell or channel (block 810). For example, the network entity (e.g., using communication manager 150 and/or transmission component 1204, depicted in FIG. 12) may transmit DCI to switch from a first set of configurations for a cell or channel to a second set of configurations for a cell or channel, as described above.

As further shown in FIG. 8, in some aspects, process 800 may include scheduling one or more communications based at least in part on a switch from the first set of configurations to the second set of configurations (block 820). For example, the network entity (e.g., using communication manager 150 and/or scheduling component 1208, depicted in FIG. 12) may schedule one or more communications based at least in part on a switch from the first set of configurations to the second set of configurations, as described above.

Process 800 may include additional aspects, such as any single aspect or any combination of aspects described below and/or in connection with one or more other processes described elsewhere herein.

In a first aspect, the DCI indicates activation or deactivation of a cell DTX mode or a cell DRX mode at the network entity.

In a second aspect, alone or in combination with the first aspect, the DCI indicates an index for a cell DTX configuration and an index for a cell DRX configuration.

In a third aspect, alone or in combination with one or more of the first and second aspects, the DCI includes a dormancy indication for one or more secondary cells.

In a fourth aspect, alone or in combination with one or more of the first through third aspects, the DCI indicates activation or deactivation of a cell DTX mode and a cell DRX mode at the network entity.

In a fifth aspect, alone or in combination with one or more of the first through fourth aspects, the first set of configurations or the second set of configurations includes one or more of a PUCCH configuration or a PDSCH configuration.

In a sixth aspect, alone or in combination with one or more of the first through fifth aspects, the first set of configurations or the second set of configurations includes a CSI-RS reporting configuration.

In a seventh aspect, alone or in combination with one or more of the first through sixth aspects, the first set of configurations or the second set of configurations includes an SRS configuration.

In an eighth aspect, alone or in combination with one or more of the first through seventh aspects, the first set of configurations or the second set of configurations includes an SR configuration.

In a ninth aspect, alone or in combination with one or more of the first through eighth aspects, the first set of configurations or the second set of configurations includes a PRACH configuration.

In a tenth aspect, alone or in combination with one or more of the first through ninth aspects, the DCI indicates deactivation of a cell DTX mode or a cell DRX mode at the network entity, and the second set of configurations includes a default configuration.

In an eleventh aspect, alone or in combination with one or more of the first through tenth aspects, the DCI includes one or more indices for the second set of configurations.

In a twelfth aspect, alone or in combination with one or more of the first through eleventh aspects, the DCI is a first DCI and indicates activation of a cell DTX mode or a cell DRX mode at the network entity, and process 800 includes transmitting a second DCI that indicates deactivation of the cell DTX mode or the cell DRX mode at the network entity.

In a thirteenth aspect, alone or in combination with one or more of the first through twelfth aspects, the DCI is a first DCI and indicates activation of a first cell DTX mode or a first cell DRX mode at the network entity, and process 800 includes transmitting a second DCI that indicates activation of a second cell DTX mode or a second cell DRX mode at the network entity.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include a switching component 908, among other examples.

In some aspects, the apparatus 900 may be configured to perform one or more operations described herein in connection with FIG. 1-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 904 may be co-located with the reception component 902 in one or more transceivers.

The reception component 902 may receive DCI to switch from a first set of configurations for a cell to a second set of configurations for the cell. The switching component 908 may switch from the first set of configurations to the second set of configurations.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

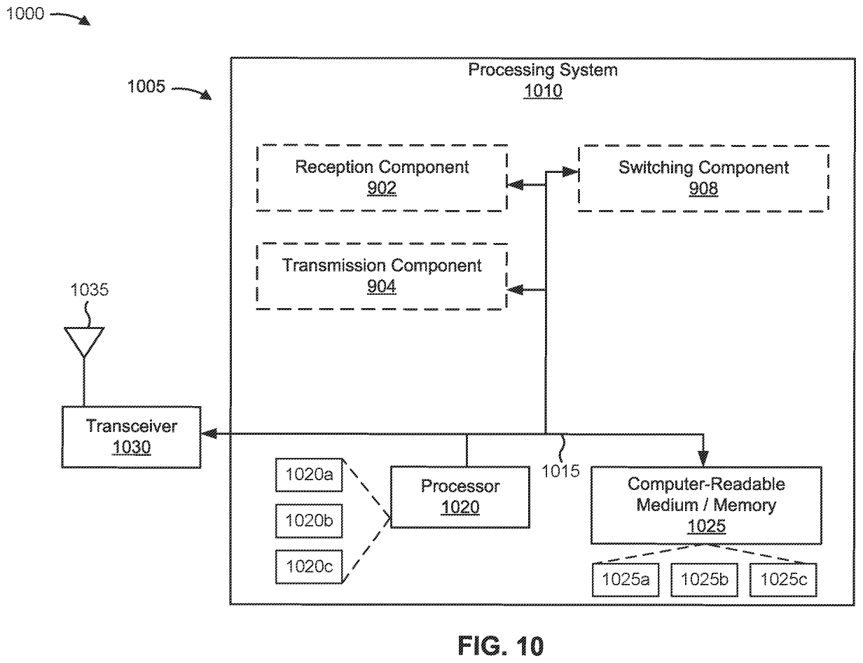

FIG. 10 is a diagram illustrating an example 1000 of a hardware implementation for an apparatus 1005 employing a processing system 1010, in accordance with the present disclosure. The apparatus 1005 may be a UE or may be at (e.g., included in) a UE.

The processing system 1010 may be implemented with a bus architecture, represented generally by the bus 1015. The bus 1015 may include any number of interconnecting buses and bridges depending on the specific application of the processing system 1010 and the overall design constraints. The bus 1015 links together various circuits including one or more processors and/or hardware components, represented by the processor (or processing circuitry) 1020, the illustrated components, and the computer-readable medium/memory (or memory circuitry) 1025. The processor 1020 may include multiple processors, such as processor 1020a, memory 1020b, and memory 1020c. The memory 1025 may include multiple memories, such as memory 1025a, memory 1025b, and memory 1025c. The bus 1015 may also link various other circuits, such as timing sources, peripherals, voltage regulators, and/or power management circuits.

The processing system 1010 may be coupled to one or more transceivers 1030. A transceiver 1030 is coupled to one or more antennas 1035. The transceiver 1030 provides a means for communicating with various other apparatuses over a transmission medium. The transceiver 1030 receives a signal from the one or more antennas 1035, extracts information from the received signal, and provides the extracted information to the processing system 1010, specifically the reception component 902. In addition, the transceiver 1030 receives information from the processing system 1010, specifically the transmission component 904, and generates a signal to be applied to the one or more antennas 1035 based at least in part on the received information.

The processing system 1010 includes one or more processors 1020 coupled to a computer-readable medium/memory 1025. A processor 1020 is responsible for general processing, including the execution of software stored on the computer-readable medium/memory 1025. The software, when executed by the processor 1020, causes the processing system 1010 to perform the various functions described herein for any particular apparatus. The computer-readable medium/memory 1025 may also be used for storing data that is manipulated by the processor 1020 when executing software. The processing system further includes at least one of the illustrated components. The components may be software modules running in the processor 1020, resident/stored in the computer readable medium/memory 1025, one or more hardware modules coupled to the processor 1020, or some combination thereof.

In some aspects, the processing system 1010 may be a component of the UE 120 and may include one or more memories, such as the memory 282, and/or may include one or more processors, such as at least one of the TX MIMO processor 266, the receive (RX) processor 258, and/or the controller/processor 280. In some aspects, the apparatus 1005 for wireless communication includes means for receiving DCI to switch from a first set of configurations for a cell to a second set of configurations for the cell; and/or means for switching from the first set of configurations to the second set of configurations. The aforementioned means may be one or more of the aforementioned components of the apparatus 900 and/or the processing system 1010 of the apparatus 1005 configured to perform the functions recited by the aforementioned means. As described elsewhere herein, the processing system 1010 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 10 is provided as an example. Other examples may differ from what is described in connection with FIG. 10.

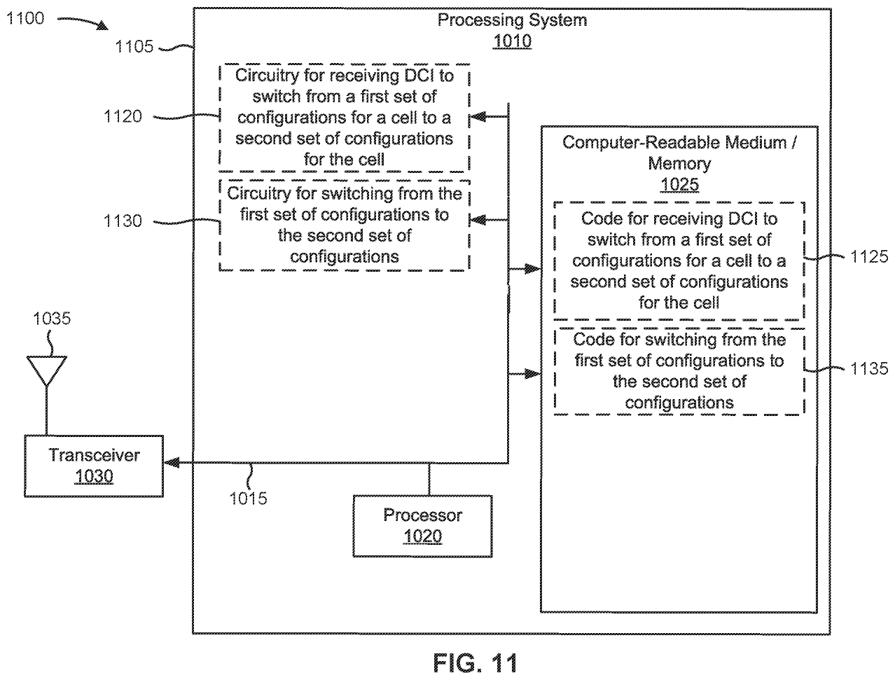

FIG. 11 is a diagram illustrating an example 1100 of an implementation of code and circuitry for an apparatus 1105, in accordance with the present disclosure. The circuitry may include processing circuitry and memory circuitry. The apparatus 1105 may be a UE, or a UE may include the apparatus 1105.

As shown in FIG. 11, the apparatus 1105 may include circuitry for receiving DCI to switch from a first set of configurations for a cell to a second set of configurations for the cell (circuitry 1120). For example, the circuitry 1120 may enable the apparatus 1105 to receive DCI to switch from a first set of configurations for a cell to a second set of configurations for the cell.

As shown in FIG. 11, the apparatus 1105 may include, stored in computer-readable medium 1025, code for receiving DCI to switch from a first set of configurations for a cell to a second set of configurations for the cell (code 1125). For example, the code 1125, when executed by processor 1020, may cause processor 1020 to receive DCI to switch from a first set of configurations for a cell to a second set of configurations for the cell.

As shown in FIG. 11, the apparatus 1105 may include circuitry for switching from the first set of configurations to the second set of configurations (circuitry 1130). For example, the circuitry 1130 may enable the apparatus 1105 to switch from the first set of configurations to the second set of configurations.

As shown in FIG. 11, the apparatus 1105 may include, stored in computer-readable medium 1025, code for switching from the first set of configurations to the second set of configurations (code 1135). For example, the code 1135, when executed by processor 1020, may cause processor 1020 to switch from the first set of configurations to the second set of configurations.

FIG. 11 is provided as an example. Other examples may differ from what is described in connection with FIG. 11.

FIG. 12 is a diagram of an example apparatus 1200 for wireless communication, in accordance with the present disclosure. The apparatus 1200 may be a network entity, or a network entity may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include a scheduling component 1208, among other examples.

In some aspects, the apparatus 1200 may be configured to perform one or more operations described herein in connection with FIGS. 1-6. Additionally, or alternatively, the apparatus 1200 may be configured to perform one or more processes described herein, such as process 800 of FIG. 8. In some aspects, the apparatus 1200 and/or one or more components shown in FIG. 12 may include one or more components of the network entity described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network entity described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, one or more modems, one or more modulators, one or more transmit MIMO processors, one or more transmit processors, one or more controllers/processors, one or more memories, or a combination thereof, of the network entity described in connection with FIG. 2. In some aspects, the transmission component 1204 may be co-located with the reception component 1202 in one or more transceivers.

The transmission component 1204 may transmit DCI to switch from a first set of configurations for a cell or channel to a second set of configurations for a cell or channel. The scheduling component 1208 may schedule one or more communications based at least in part on a switch from the first set of configurations to the second set of configurations.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

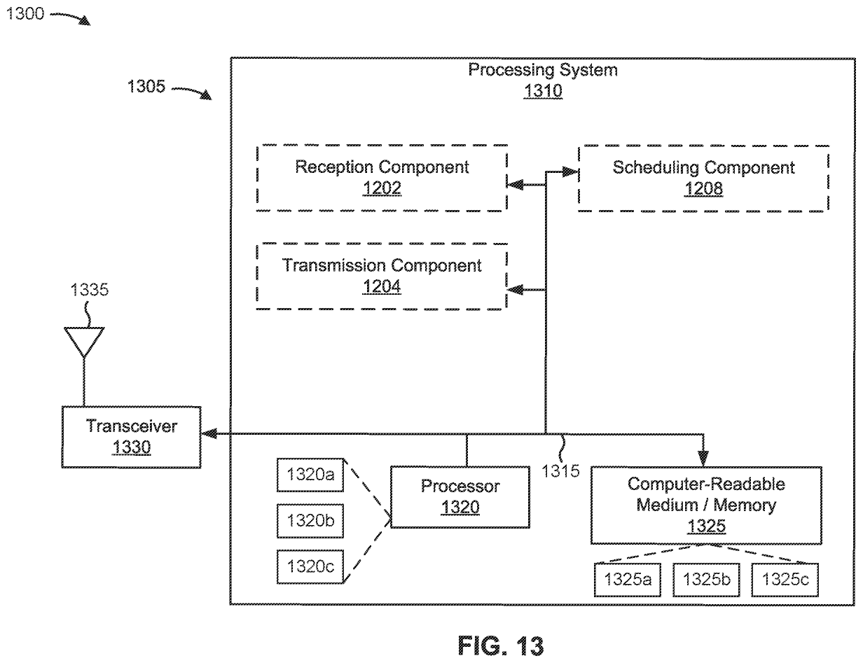

FIG. 13 is a diagram illustrating an example 1300 of a hardware implementation for an apparatus 1305 employing a processing system 1310, in accordance with the present disclosure. The apparatus 1305 may be a network entity or may be at (e.g., included in) a network entity.

The processing system 1310 may be implemented with a bus architecture, represented generally by the bus 1315. The bus 1315 may include any number of interconnecting buses and bridges depending on the specific application of the processing system 1310 and the overall design constraints. The bus 1315 links together various circuits including one or more processors and/or hardware components, represented by the processor (or processing circuitry) 1320, the illustrated components, and the computer-readable medium/memory (or memory circuitry) 1325. The processor 1320 may include multiple processors, such as processor 1320a, memory 1320b, and memory 1320c. The memory 1325 may include multiple memories, such as memory 1325a, memory 1325b, and memory 1325c. The bus 1315 may also link various other circuits, such as timing sources, peripherals, voltage regulators, and/or power management circuits.

The processing system 1310 may be coupled to one or more transceivers 1330. A transceiver 1330 is coupled to one or more antennas 1335. The transceiver 1330 provides a means for communicating with various other apparatuses over a transmission medium. The transceiver 1330 receives a signal from the one or more antennas 1335, extracts information from the received signal, and provides the extracted information to the processing system 1310, specifically the reception component 1202. In addition, the transceiver 1330 receives information from the processing system 1310, specifically the transmission component 1204, and generates a signal to be applied to the one or more antennas 1335 based at least in part on the received information.

The processing system 1310 includes one or more processors 1320 coupled to a computer-readable medium/memory 1325. A processor 1320 is responsible for general processing, including the execution of software stored on the computer-readable medium/memory 1325. The software, when executed by the processor 1320, causes the processing system 1310 to perform the various functions described herein for any particular apparatus. The computer-readable medium/memory 1325 may also be used for storing data that is manipulated by the processor 1320 when executing software. The processing system further includes at least one of the illustrated components. The components may be software modules running in the processor 1320, resident/stored in the computer readable medium/memory 1325, one or more hardware modules coupled to the processor 1320, or some combination thereof.

In some aspects, the processing system 1310 may be a component of the network node 110 and may include one or more memories, such as the memory 242, and/or may include one or more processors, such as at least one of the TX MIMO processor 230, the RX processor 238, and/or the controller/processor 240. In some aspects, the apparatus 1305 for wireless communication includes means for transmitting DCI to switch from a first set of configurations for a cell or channel to a second set of configurations for a cell or channel; and/or means for scheduling one or more communications based at least in part on a switch from the first set of configurations to the second set of configurations. The aforementioned means may be one or more of the aforementioned components of the apparatus 1200 and/or the processing system 1310 of the apparatus 1305 configured to perform the functions recited by the aforementioned means. As described elsewhere herein, the processing system 1310 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 13 is provided as an example. Other examples may differ from what is described in connection with FIG. 13.

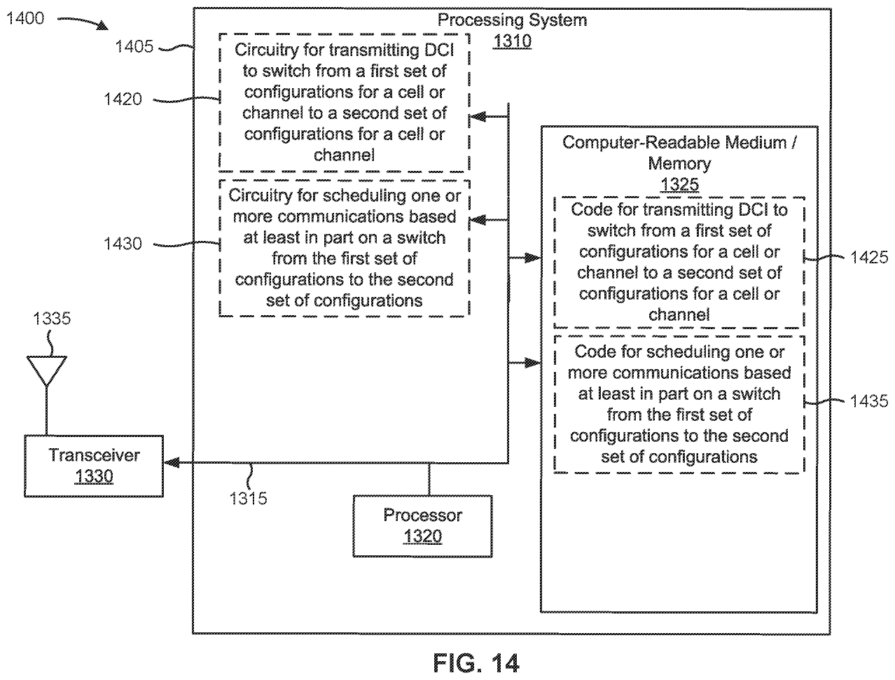

FIG. 14 is a diagram illustrating an example 1400 of an implementation of code and circuitry for an apparatus 1405, in accordance with the present disclosure. The apparatus 1405 may be a network entity, or a network entity may include the apparatus 1405.

As shown in FIG. 14, the apparatus 1405 may include circuitry for transmitting DCI to switch from a first set of configurations for a cell or channel to a second set of configurations for a cell or channel (circuitry 1420). For example, the circuitry 1420 may enable the apparatus 1405 to transmit DCI to switch from a first set of configurations for a cell or channel to a second set of configurations for a cell or channel.

As shown in FIG. 14, the apparatus 1405 may include, stored in computer-readable medium 1325, code for transmitting DCI to switch from a first set of configurations for a cell or channel to a second set of configurations for a cell or channel (code 1425). For example, the code 1425, when executed by processor 1320, may cause processor 1320 to transmit DCI to switch from a first set of configurations for a cell or channel to a second set of configurations for a cell or channel.

As shown in FIG. 14, the apparatus 1405 may include circuitry for scheduling one or more communications based at least in part on a switch from the first set of configurations to the second set of configurations (circuitry 1430). For example, the circuitry 1430 may enable the apparatus 1405 to schedule one or more communications based at least in part on a switch from the first set of configurations to the second set of configurations.

As shown in FIG. 14, the apparatus 1405 may include, stored in computer-readable medium 1325, code for scheduling one or more communications based at least in part on a switch from the first set of configurations to the second set of configurations (code 1435). For example, the code 1435, when executed by processor 1320, may cause processor 1320 to cause transceiver 1330 to schedule one or more communications based at least in part on a switch from the first set of configurations to the second set of configurations. This may include the transceiver 1330 transmitting a grant to one or more UEs.

FIG. 14 is provided as an example. Other examples may differ from what is described in connection with FIG. 14.

The following provides an overview of some Aspects of the present disclosure:

Aspect 1: A method of wireless communication performed at a user equipment (UE), comprising: receiving downlink control information (DCI) to switch from a first set of configurations for a cell to a second set of configurations for the cell; and switching from the first set of configurations to the second set of configurations.

Aspect 2: The method of Aspect 1, wherein the DCI indicates activation or deactivation of a cell discontinuous transmission (DTX) mode or a cell discontinuous reception (DRX) mode at a network entity.

Aspect 3: The method of Aspect 2, wherein the DCI indicates an index for a cell DTX configuration and an index for a cell DRX configuration.

Aspect 4: The method of Aspect 2, wherein the cell is a primary cell, and wherein the DCI includes a dormancy indication for one or more secondary cells.

Aspect 5: The method of Aspect 2, wherein the DCI indicates activation or deactivation of a cell discontinuous transmission (DTX) mode or a cell discontinuous reception (DRX) mode at a network entity.

Aspect 6: The method of any of Aspects 1-5, wherein switching from the first set of configurations to the second set of configurations includes switching from a first type of configuration to a second type of configuration.

Aspect 7: The method of any of Aspects 1-6, wherein switching from the first set of configurations to the second set of configurations includes increasing or decreasing a transmit power.

Aspect 8: The method of any of Aspects 1-7, wherein the first set of configurations or the second set of configurations includes one or more of a physical uplink control channel configuration or a physical downlink shared channel configuration.

Aspect 9: The method of any of Aspects 1-8, wherein the first set of configurations or the second set of configurations includes a channel state information reference signal reporting configuration.

Aspect 10: The method of any of Aspects 1-9, wherein the first set of configurations or the second set of configurations includes a sounding reference signal configuration.

Aspect 11: The method of any of Aspects 1-10, wherein the first set of configurations or the second set of configurations includes a scheduling request configuration.

Aspect 12: The method of any of Aspects 1-11, wherein the first set of configurations or the second set of configurations includes a physical random access channel configuration.

Aspect 13: The method of any of Aspects 1-12, wherein the DCI indicates deactivation of a cell discontinuous transmission mode or a cell discontinuous reception mode at a network entity, and wherein the second set of configurations includes a default configuration.

Aspect 14: The method of any of Aspects 1-13, wherein the DCI includes one or more indices for the second set of configurations.

Aspect 15: The method of any of Aspects 1-14, wherein the DCI is a first DCI and indicates activation of a cell discontinuous transmission (DTX) mode or a cell discontinuous reception (DRX) mode at a network entity, and wherein the method includes receiving a second DCI that indicates deactivation of the cell DTX mode or the cell DRX mode at the network entity.

Aspect 16: The method of any of Aspects 1-15, wherein the DCI is a first DCI and activates a first cell discontinuous transmission (DTX) mode or a first cell discontinuous reception (DRX) mode at a network entity, and wherein the method includes receiving a second DCI that indicates activation of a second cell DTX mode or a second cell DRX mode at the network entity.

Aspect 17: A method of wireless communication performed at a network entity, comprising: transmitting downlink control information (DCI) to switch from a first set of configurations for a cell or channel to a second set of configurations for a cell or channel; and scheduling one or more communications based at least in part on a switch from the first set of configurations to the second set of configurations.

Aspect 18: The method of Aspect 17, wherein the DCI indicates activation or deactivation of a cell discontinuous transmission (DTX) mode or a cell discontinuous reception (DRX) mode at the network entity.

Aspect 19: The method of Aspect 18, wherein the DCI indicates an index for a cell DTX configuration and an index for a cell DRX configuration.

Aspect 20: The method of Aspect 18, wherein the DCI includes a dormancy indication for one or more secondary cells.

Aspect 21: The method of Aspect 18, wherein the DCI indicates activation or deactivation of a cell discontinuous transmission (DTX) mode and a cell discontinuous reception (DRX) mode at the network entity.

Aspect 22: The method of any of Aspects 17-21, wherein the first set of configurations or the second set of configurations includes one or more of a physical uplink control channel configuration or a physical downlink shared channel configuration.

Aspect 23: The method of any of Aspects 17-22, wherein the first set of configurations or the second set of configurations includes a channel state information reference signal reporting configuration.

Aspect 24: The method of any of Aspects 17-23, wherein the first set of configurations or the second set of configurations includes a sounding reference signal configuration.

Aspect 25: The method of any of Aspects 17-24, wherein the first set of configurations or the second set of configurations includes a scheduling request configuration.

Aspect 26: The method of any of Aspects 17-25, wherein the first set of configurations or the second set of configurations includes a physical random access channel configuration.

Aspect 27: The method of any of Aspects 17-26, wherein the DCI indicates deactivation of a cell discontinuous transmission mode or a cell discontinuous reception mode at the network entity, and wherein the second set of configurations includes a default configuration.

Aspect 28: The method of any of Aspects 17-27, wherein the DCI includes one or more indices for the second set of configurations.

Aspect 29: The method of any of Aspects 17-28, wherein the DCI is a first DCI and indicates activation of a cell discontinuous transmission (DTX) mode or a cell discontinuous reception (DRX) mode at the network entity, and wherein the method includes transmitting a second DCI that indicates deactivation of the cell DTX mode or the cell DRX mode at the network entity.

Aspect 30: The method of any of Aspects 17-29, wherein the DCI is a first DCI and indicates activation of a first cell discontinuous transmission (DTX) mode or a first cell discontinuous reception (DRX) mode at the network entity, and wherein the method includes transmitting a second DCI that indicates activation of a second cell DTX mode or a second cell DRX mode at the network entity.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

Aspect 32: An apparatus for wireless communication at a device, the apparatus comprising one or more memories and one or more processors coupled to the one or more memories, the one or more processors configured to cause the device to perform the method of one or more of Aspects 1-30.

Aspect 33: An apparatus for wireless communication, the apparatus comprising at least one means for performing the method of one or more of Aspects 1-30.

Aspect 34: A non-transitory computer-readable medium storing code for wireless communication, the code comprising instructions executable by one or more processors to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A device for wireless communication, the device comprising a processing system that includes one or more processors and one or more memories coupled with the one or more processors, the processing system configured to cause the device to perform the method of one or more of Aspects 1-30.

Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

Aspect 38: An apparatus for wireless communication at a user equipment (UE), comprising: a processing system that includes processor circuitry and memory circuitry that stores code and is coupled with the processor circuitry, the processing system configured to cause the UE to perform the method of one or more of Aspects 1-16.

Aspect 39: An apparatus for wireless communication at a network entity, comprising: a processing system that includes processor circuitry and memory circuitry that stores code and is coupled with the processor circuitry, the processing system configured to cause the network entity to perform the method of one or more of Aspects 17-30.

Aspect 40: An apparatus for wireless communication at a user equipment (UE), comprising: one or more memories; and one or more processors coupled to the one or more memories, the one or more processors configured to cause the UE to: receive downlink control information (DCI) to switch from a first set of configurations for a cell to a second set of configurations for the cell; and switch from the first set of configurations to the second set of configurations.

Aspect 41: The apparatus of Aspect 40, wherein the one or more processors are configured, individually or collectively, to cause the UE to: receive downlink control information (DCI) to switch from a first set of configurations for a cell to a second set of configurations for the cell; and switch from the first set of configurations to the second set of configurations.

Aspect 42: An apparatus for wireless communication at a network entity, comprising: one or more memories; and one or more processors coupled to the one or more memories, the one or more processors configured to cause the network entity to: transmit downlink control information (DCI) to switch from a first set of configurations for a cell or channel to a second set of configurations for a cell or channel; and schedule one or more communications based at least in part on a switch from the first set of configurations to the second set of configurations.

Aspect 43: The apparatus of Aspect 42, wherein the one or more processors are configured, individually or collectively, to cause the network entity to: transmit downlink control information (DCI) to switch from a first set of configurations for a cell or channel to a second set of configurations for a cell or channel; and schedule one or more communications based at least in part on a switch from the first set of configurations to the second set of configurations.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, coupled to the one or more memories, configured to cause the UE to:
receive downlink control information (DCI) to switch from a first set of configurations for a cell to a second set of configurations for the cell; and
switch from the first set of configurations to the second set of configurations.

2. The apparatus of claim 1, wherein the DCI indicates activation or deactivation of a cell discontinuous transmission (DTX) mode or a cell discontinuous reception (DRX) mode at a network entity.

3. The apparatus of claim 2, wherein the DCI indicates an index for a cell DTX configuration and an index for a cell DRX configuration.

4. The apparatus of claim 2, wherein the cell is a primary cell, and wherein the DCI includes a dormancy indication for one or more secondary cells.

5. The apparatus of claim 2, wherein the DCI indicates activation or deactivation of a cell discontinuous transmission (DTX) mode or a cell discontinuous reception (DRX) mode at a network entity.

6. The apparatus of claim 1, wherein to switch from the first set of configurations to the second set of configurations, the one or more processors are configured to cause the UE to switch from a first type of configuration to a second type of configuration.

7. The apparatus of claim 1, wherein to switch from the first set of configurations to the second set of configurations, the one or more processors are configured to cause the UE to increase or decreasing a transmit power.

8. The apparatus of claim 1, wherein the first set of configurations or the second set of configurations includes one or more of a physical uplink control channel configuration or a physical downlink shared channel configuration.

9. The apparatus of claim 1, wherein the first set of configurations or the second set of configurations includes a channel state information reference signal reporting configuration.

10. The apparatus of claim 1, wherein the first set of configurations or the second set of configurations includes a sounding reference signal configuration.

11. The apparatus of claim 1, wherein the first set of configurations or the second set of configurations includes a scheduling request configuration.

12. The apparatus of claim 1, wherein the first set of configurations or the second set of configurations includes a physical random access channel configuration.

13. The apparatus of claim 1, wherein the DCI indicates deactivation of a cell discontinuous transmission mode or a cell discontinuous reception mode at a network entity, and wherein the second set of configurations includes a default configuration.

14. The apparatus of claim 1, wherein the DCI includes one or more indices for the second set of configurations.

15. The apparatus of claim 1, wherein the DCI is a first DCI and indicates activation of a cell discontinuous transmission (DTX) mode or a cell discontinuous reception (DRX) mode at a network entity, and wherein the one or more processors are configured to cause the UE to receive a second DCI that indicates deactivation of the cell DTX mode or the cell DRX mode at the network entity.

16. The apparatus of claim 1, wherein the DCI is a first DCI and activates a first cell discontinuous transmission (DTX) mode or a first cell discontinuous reception (DRX) mode at a network entity, and wherein the one or more processors are configured to cause the UE to receive a second DCI that indicates activation of a second cell DTX mode or a second cell DRX mode at the network entity.

17. An apparatus for wireless communication at a network entity, comprising:
one or more memories; and
one or more processors, coupled to the one or more memories, configured to cause the network entity to:
transmit downlink control information (DCI) to switch from a first set of configurations for a cell or channel to a second set of configurations for a cell or channel; and
schedule one or more communications based at least in part on a switch from the first set of configurations to the second set of configurations.

18. The apparatus of claim 17, wherein the DCI indicates activation or deactivation of a cell discontinuous transmission (DTX) mode or a cell discontinuous reception (DRX) mode at the network entity.

19. The apparatus of claim 17, wherein the DCI indicates an index for a cell DTX configuration and an index for a cell DRX configuration.

20. The apparatus of claim 17, wherein the DCI includes a dormancy indication for one or more secondary cells.

21. The apparatus of claim 17, wherein the first set of configurations or the second set of configurations includes one or more of a physical uplink control channel configuration or a physical downlink shared channel configuration.

22. The apparatus of claim 17, wherein the first set of configurations or the second set of configurations includes a channel state information reference signal reporting configuration.

23. The apparatus of claim 17, wherein the first set of configurations or the second set of configurations includes a sounding reference signal configuration.

24. The apparatus of claim 17, wherein the first set of configurations or the second set of configurations includes a scheduling request configuration.

25. The apparatus of claim 17, wherein the first set of configurations or the second set of configurations includes a physical random access channel configuration.

26. The apparatus of claim 17, wherein the DCI indicates deactivation of a cell discontinuous transmission mode or a cell discontinuous reception mode at the network entity, and wherein the second set of configurations includes a default configuration.

27. The apparatus of claim 17, wherein the DCI includes one or more indices for the second set of configurations.

28. The apparatus of claim 17, wherein the DCI is a first DCI and indicates activation of a cell discontinuous transmission (DTX) mode or a cell discontinuous reception (DRX) mode at the network entity, and wherein the one or more processors are configured to cause the network entity to transmit a second DCI that indicates deactivation of the cell DTX mode or the cell DRX mode at the network entity.

29. The apparatus of claim 17, wherein the DCI is a first DCI and indicates activation of a first cell discontinuous transmission (DTX) mode or a first cell discontinuous reception (DRX) mode at the network entity, and wherein the one or more processors are configured to cause the network entity to transmit a second DCI that indicates activation of a second cell DTX mode or a second cell DRX mode at the network entity.

30. A method of wireless communication performed at a user equipment (UE), comprising:
receiving downlink control information (DCI) to switch from a first set of configurations for a cell to a second set of configurations for the cell; and
switching from the first set of configurations to the second set of configurations.
